(19) United States
(12) Patent Application Publication
(10) Pub. No.: US 2019/0210197 A1
(43) Pub. Date: Jul. 11, 2019

(54) SPARK PLUG INSTALLATION AND REMOVAL TOOL

(71) Applicant: Ralph L. Baldonado, Silver City, NM (US)

(72) Inventor: Ralph L. Baldonado, Silver City, NM (US)

(21) Appl. No.: 15/868,210

(22) Filed: Jan. 11, 2018

(51) Int. Cl. B25B 13/48; B25G 1/10

(52) U.S. Cl. CPC B25B 13/483; B25G 1/102

(57) ABSTRACT

A spark plug tool comprises a flexible cylindrical body with a cavity into which a spark plug may be inserted. The cylindrical body has ridges extending along at least a portion of the body between a first end having the cavity and an opposite end. Embodiments may include other features, such as a weight and/or gripping portion for ease of use.

### BACKGROUND

Spark plug installation and removal in auto repair and maintenance can be difficult, given accessibility to the spark plugs and other factors. Traditional tools for spark plug installation and removal typically have rigid bodies that can make it difficult for a mechanic to “feel” the threads catching, increasing the likelihood of stripping threads during installation. Moreover, the rigidity of traditional tools may also increase the likelihood that the spark plug can break during removal.

### BRIEF SUMMARY

This spark plug tool comprises a flexible cylindrical body with a cavity into which a spark plug may be inserted. The cylindrical body has ridges extending along at least a portion of the body between a first end having the cavity and an opposite end. Embodiments may include other features, such as a weight and/or gripping portion for ease of use.

An example spark plug tool, according to the description, comprises a flexible cylindrical member having a first end, a second end, and an outer surface extending in an axial direction between the first end and the second end, and a plurality of ridges disposed on the outer surface. Each ridge of the plurality of ridges rises above the outer surface in a radial direction, extends along the axial direction of the cylindrical member, and is spaced disposed such that a human finger may be positioned between the respective ridge and an adjacent ridge. The spark plug tool further comprises a cavity configured for receiving a portion of a spark plug, where the cavity extends into the first end of the cylindrical member and having a cavity wall configured for engaging a perimeter surface of the spark plug to install or remove the spark plug from an engine. The spark plug tool also comprises a weight disposed on or in the cylindrical member between a center portion of the cylindrical member and the second end.

Embodiments of the spark plug tool can comprise one or more of the following additional features. The spark plug tool may further comprise a gripping portion coupled to second end of the cylindrical member, wherein the plurality of ridges do not extend to the gripping portion. The gripping portion may comprise a plurality of faces substantially perpendicular to an axis of the cylindrical member. The cavity may have a circular opening. A diameter of the circular opening may be ⅜ inches. A depth of the cavity is at least 2 inches. A spacing between adjacent ridges of the plurality of ridges may be at least ⅛ inches. The cylindrical member may comprise rubber. A portion of the cylindrical member into which the cavity extends may have a larger circumference than a portion of the cylindrical member into which the cavity does not extend. The cylindrical member may have a length along the axial direction of at least 4 inches or at least 8 inches.

According to another embodiment in the description, a spark plug tool may comprise a flexible cylindrical member having a first end, a second end, and an outer surface extending in an axial direction between the first end and the second end, and a plurality of ridges disposed on the outer surface. Each ridge of the plurality of ridges rises above the outer surface in a radial direction, extends along the axial direction of the cylindrical member, and is spaced disposed such that a human finger may be positioned between the respective ridge and an adjacent ridge. The spark plug took further comprises a cavity configured for receiving a portion of a spark plug, the cavity extending into the first end of the cylindrical member and having a cavity wall configured for engaging a perimeter surface of the spark plug to install or remove the spark plug from an engine. The spark plug tool also comprises a gripping portion coupled to second end of the cylindrical member.

Embodiments of the spark plug tool can comprise one or more of the following additional features. The gripping portion may comprise a plurality of faces substantially perpendicular to an axis of the cylindrical member further comprising. The spark plug tool may further comprise a weight disposed on or in the cylindrical member between a center portion of the cylindrical member and the second end. The cavity may have a circular opening. A diameter of the circular opening may be ⅜ inches. A depth of the cavity may be at least 2 inches. A spacing between adjacent ridges of the plurality of ridges may be at least 0.25 inches. The cylindrical member may comprise rubber. A portion of the cylindrical member into which the cavity extends may have a larger circumference than a portion of the cylindrical member into which the cavity does not extend.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is an illustration of a spark plug tool, according to an embodiment;

FIGS. 2A and 2B are illustrations showing the process of inserting a spark plug into the spark plug tool, according to embodiments;

FIG. 3A is an illustration of an end view of the spark plug tool of FIG. 1; and

FIG. 3B is an illustration of a cross-section of the spark plug tool of FIG. 1 (the cross section as indicated in FIG. 3A).

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION OF THE INVENTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

As previously mentioned, traditional spark plug installation tools often have rigid bodies (e.g., made of metal) that can make it difficult not only to maneuver to the spark plug opening, but also to enable the user to feel whether the threads of the spark plug successfully catch the threads of the spark plug socket without stripping. Because of these difficulties, mechanics would often use a rubber hose to install (or remove) a spark plug. However, rubber hoses may not provide easy gripping and they can wear unevenly after several uses.

As illustrated in the embodiments that follow, a spark plug tool is provided that comprises a flexible cylindrical member with a cavity on one end for engaging with a spark plug, and ridges running lengthwise (along an axial direction). According to embodiments, the spark plug tool may further comprise a weight to provide a better balance and feel to the tool. The appended figures and accompanying description below provide additional detail.

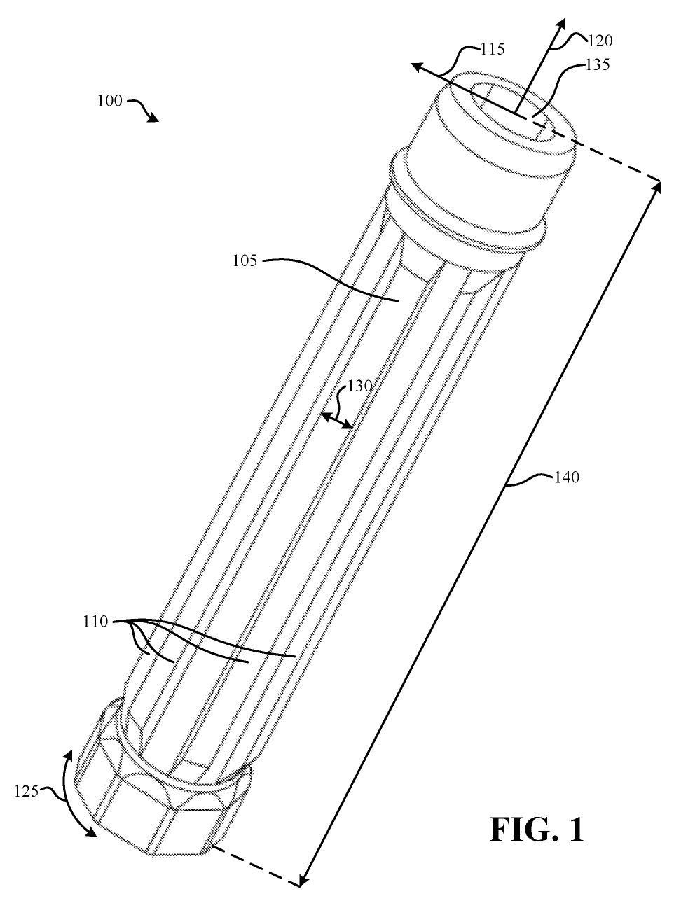

FIG. 1 is an illustration of a spark plug tool 100, according to an embodiment. The spark plug tool 100 comprises a flexible cylindrical member 105, which can be made of a durable, elastic material, such as rubber (e.g., high-temperature rubber).

The spark plug tool 100 can also include a plurality of ridges 110, which may rise outward above an outer surface of the cylindrical member 105 (e.g., in a radial direction 115 outward from an axial direction 120 of the cylindrical body). These ridges 110 may vary in number, size, and spacing, depending on desired functionality. Generally, however, the ridges may be sized, spaced, and/or numbered to provide additional rigidity to the cylindrical body and/or enable a user to more easily grip the spark plug tool 100 along the cylindrical member 105, to apply torque in circumferential directions 125 to install or remove a spark plug. To help enable this, the spacing 130 between ridges 110 may be such that a human finger may be positioned between adjacent ridges. In some embodiments, for example, the spacing 130 can be at least ⅛ inches.

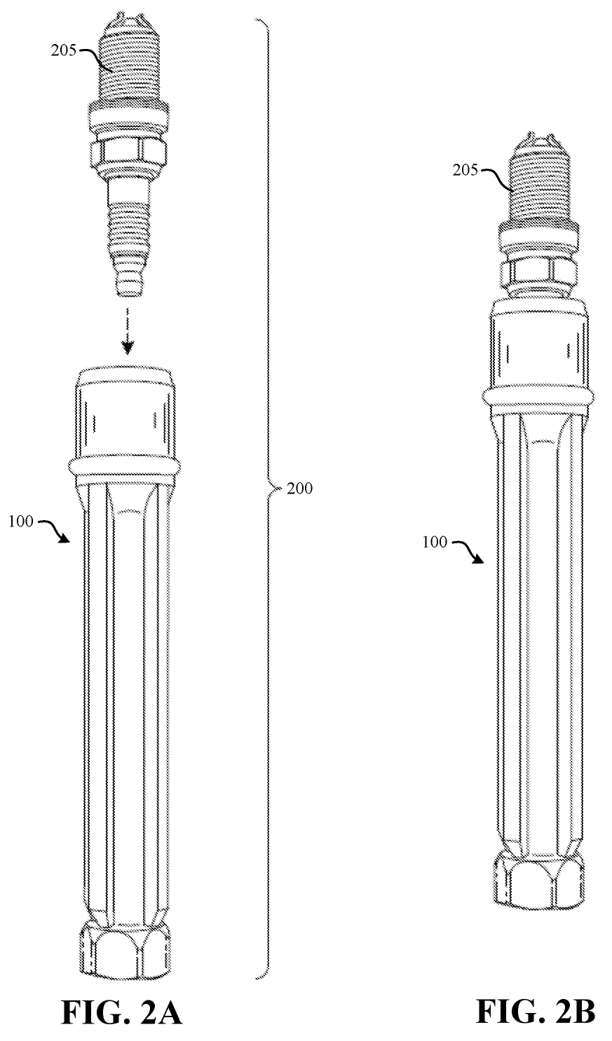

One end of the cylindrical member 105 comprises a cavity 135 into which a spark plug can be inserted when the spark plug tool 100 is in use. FIGS. 2A and 2B illustrate the process of inserting a spark plug into the spark plug tool, according to embodiments.

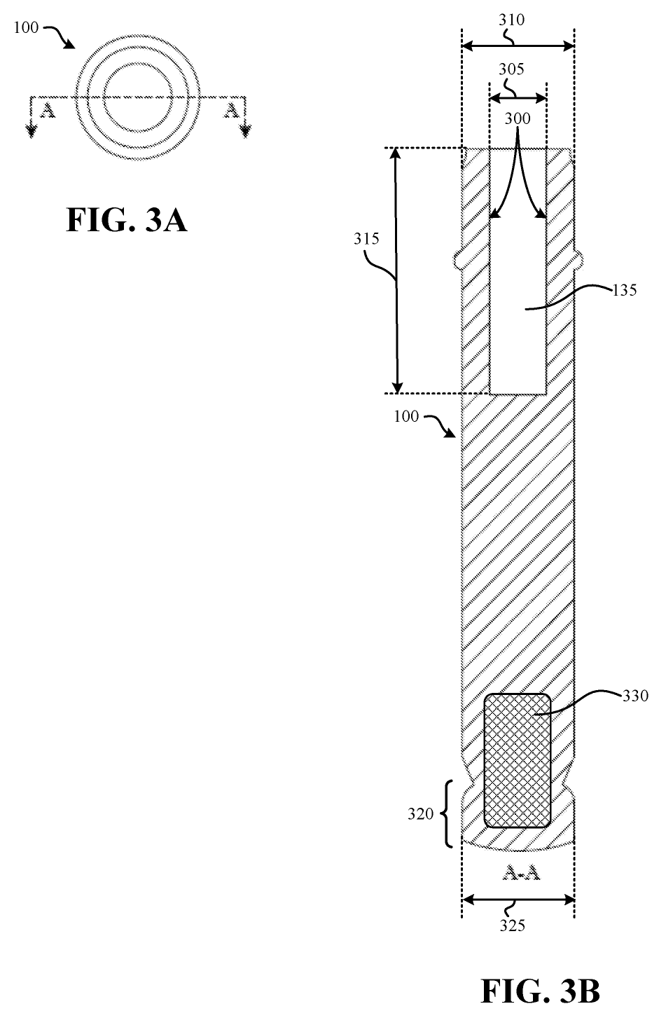

FIG. 2A shows a configuration 200 in which a spark plug 205 is inserted into the cavity of the spark plug tool 100, resulting in the engaged configuration illustrated in FIG. 2B. To help ensure the spark plug tool 100 properly engages with the spark plug 205 (enabling a sufficient grip of the spark plug 205 to allow the tool to be used to thread the spark plug 205 into a spark plug cavity in an engine) the cavity may be sized and shaped accordingly. FIGS. 3A and 3B provide additional details.

FIG. 3A is an illustration of an end view of the spark plug tool 100 (the end opposite the end with the cavity 135), and FIG. 3B is an illustration of a cross-section of the spark plug tool 100 (the cross section of the tool as indicated in FIG. 3A).

During operation, the cavity wall may engage with a perimeter surface of a spark plug, holding the spark plug (e.g., the porcelain surface of the spark plug) with sufficient tension to apply a rotary force in a circumferential direction (item 125 of FIG. 1) around the axis (item 120 of FIG. 1) to thread or unthread the spark plug during installation or removal. As such, the cavity wall 300 may comprise the same flexible material (e.g., rubber) as the cylindrical member. When engaged with a spark plug, the cavity wall 300 may provide enough tension on the spark plug to ensure it remains in place as the spark plug tool 100 is being inserted into or extracted from an engine (minimizing the likelihood that the spark plug might fall out and possibly break during installation/removal), yet also provide enough give so as to allow the tool to slip when a large rotary force is applied, rather than possibly break the spark plug and/or stripping the threads on the spark plug or inside the head of the engine.

As noted above, the size and shape of the cavity 135 can be configured to accommodate a spark plug and ensure engagement between the spark plug and the cavity wall. Although the cavity is cylindrically shaped in FIG. 3, embodiments are not so limited. In some embodiments, for example, the cavity may taper inward, so the end of the cavity has a smaller radius than the opening of the cavity. In some embodiments, the shape of the cavity may generally match the profile of a spark plug, to help ensure the cavity wall 300 engages with the spark plug at many locations. In some embodiments, the opening of the cavity 135 may be circular and/or may have a diameter 305 of ⅜ inch. Other embodiments may have a larger or smaller diameter 305.

The width 310 of the end of the spark plug tool 100 into which the cavity 135 extends may vary, depending on desired functionality. In some embodiments, the width 310 may be chosen to help ensure the tool remains durable after repeated use. In some embodiments this width 310 is ⅞ inches. Other embodiments may have a larger or smaller width 310.

Just as the shape and size of the opening of the cavity 135 can vary, so too can the depth 315. The depth 315 of the cavity (and the diameter 305) may vary based on factors such as a type of spark plug(s) with which the spark plug tool 100 is to be used, the diameter 305 of the opening, the elasticity of the material(s) with which the spark plug tool 100 (or at least the cavity walls 300) is/are made, and the like. In some embodiments, the depth 315 sat least 2 inches. In other embodiments, the depth 315 may be longer or shorter. In some embodiments, a portion of the cylindrical member into which the cavity extends has a larger circumference than a portion of the cylindrical member into which the cavity does not extend.

As illustrated in FIGS. 1-3B, the spark plug tool 100 may further comprise a gripping portion 320 coupled to an end of the tool opposite the end with the cavity 135. Referring again to FIG. 1, although the cylindrical member may include ridges 110 that can facilitate gripping of the spark plug tool 100 may be inserted deep inside a head or under a valve cover of an engine when in use. Thus, in some instances, the gripping portion 320 may be the only portion of the spark plug tool 100 a user may be able to easily grip during installation or removal of a spark plug.

The size and shape of the gripping portion can vary, depending on desired functionality. In some embodiments, for example, the width 325 of the gripping portion 320 may be wider than the width 310 of the opposite end and/or body of the cylindrical member of the spark plug tool 100. In some embodiments, the width 325 of the gripping potion 320 may be 1 inch. As illustrated in FIG. 1, the ridges 110 may not extend to the gripping portion 320, but the gripping potion may include a plurality of faces perpendicular to the axis 120 of the cylindrical member 105 and/or contours to help facilitate a user's grip on the gripping portion 320.

The spark plug tool 100 additionally or alternatively may include a counterweight to provide balance to the spark plug tool 100, facilitating its use. Referring again to FIG. 3B, a weight 330 may be disposed on or in the cylindrical member between a center portion of the cylindrical member and the end opposite the cavity 135. The weight 330 may comprise a metal (e.g., iron, steel, etc.) and/or other material(s) heavier than other material(s) with which the spark plug tool 100 is made. In some embodiments, the weight may be embedded wholly or partially within the cylindrical body, in other embodiments, the weight may be coupled to an outside surface of the spark plug tool 100. In some embodiments, more than one weight may be used.

The position of the weight may also vary, depending on desired functionality, manufacturing concerns, and/or other factors. For instance, as illustrated in FIG. 3B, the weight may be embedded within portions of both the cylindrical body and gripping portion 320 of the spark plug tool 100. In other embodiments, the weight may be wholly embedded within either the cylindrical body or gripping portion 320 of the spark plug tool.

Finally, the length of the spark plug tool 100 can vary, depending on desired functionality. Referring again to FIG. 1, the length 140 can be chosen to be long enough to (together with the flexibility of the spark plug tool 100) enable a user to go between exhaust headers, valve covers, and the like, while enabling proper installation and/or removal of the spark plug.

Different spark plug tools 100 may have different lengths 140 to accommodate different applications. A spark plug tool 100 may have a relatively shorter length 140 (e.g., at least 4 inches) to accommodate older cars with spark plugs located on the side of the engine. Another spark plug tool 100 may have a relatively longer length 140 (e.g., at least 8 inches) to accommodate newer cars with spark plug openings located on the top of the engine. Spark plug tools 100 with other lengths (e.g., shorter than 4 inches, longer than 8 inches, etc.) may be created for other applications.

Various components may be described herein as being “configured” to perform various operations. Those skilled in the art will recognize that, depending on implementation, such configuration can be accomplished through design, material, structure, and the like, and, again depending on implementation, a configured component might or might not be reconfigurable for a different operation. Moreover, for many functions described herein, specific means have also been described as being capable of performing such functions. It can be understood, however, that functionality is not limited to the means disclosed. A person of ordinary skill in the art will appreciate that alternative means for performing similar functions may additionally or alternatively be used to those means described herein.

It will be apparent to those skilled in the art that substantial variations to the embodiments provided herein may be made in accordance with specific requirements. For example, size, shape, materials, components, and/or other features may vary. Various embodiments may omit, substitute, or add components as appropriate. For instance, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A spark plug tool comprising:
a flexible cylindrical member having a first end, a second end, and an outer surface extending in an axial direction between the first end and the second end;
a plurality of ridges disposed on the outer surface, wherein each ridge of the plurality of ridges:
rises above the outer surface in a radial direction, extends along the axial direction of the cylindrical member, and is spaced disposed such that a human finger may be positioned between the respective ridge and an adjacent ridge;
a cavity configured for receiving a portion of a spark plug, the cavity extending into the first end of the cylindrical member and having a cavity wall configured for engaging a perimeter surface of the spark plug to install or remove the spark plug from an engine; and
a weight disposed on or in the cylindrical member between a center portion of the cylindrical member and the second end.

2. The spark plug tool of claim 1, further comprising a gripping portion coupled to second end of the cylindrical member, wherein the plurality of ridges do not extend to the gripping portion.

3. The spark plug tool of claim 2, wherein the gripping portion comprises a plurality of faces substantially perpendicular to an axis of the cylindrical member.

4. The spark plug tool of claim 1, wherein the cavity has a circular opening.

5. The spark plug tool of claim 4, wherein a diameter of the circular opening is ⅜ inches.

6. The spark plug tool of claim 1, wherein a depth of the cavity is at least 2 inches.

7. The spark plug tool of claim 1, wherein a spacing between adjacent ridges of the plurality of ridges is at least ⅛ inches.

8. The spark plug tool of claim 1, wherein the cylindrical member comprises rubber.

9. The spark plug tool of claim 1, wherein a portion of the cylindrical member into which the cavity extends has a larger circumference than a portion of the cylindrical member into which the cavity does not extend.

10. The spark plug tool of claim 1, wherein the cylindrical member has a length along the axial direction of at least 4 inches.

11. The spark plug tool of claim 10, wherein the cylindrical member has a length along the axial direction of at least 8 inches.

12. A spark plug tool comprising:
a flexible cylindrical member having a first end, a second end, and an outer surface extending in an axial direction between the first end and the second end;
a plurality of ridges disposed on the outer surface, wherein each ridge of the plurality of ridges:
rises above the outer surface in a radial direction,
extends along the axial direction of the cylindrical member, and
is spaced disposed such that a human finger may be positioned between the respective ridge and an adjacent ridge;
a cavity configured for receiving a portion of a spark plug, the cavity extending into the first end of the cylindrical member and having a cavity wall configured for engaging a perimeter surface of the spark plug to install or remove the spark plug from an engine; and
a gripping portion coupled to second end of the cylindrical member.

13. The spark plug tool of claim 12, the gripping portion comprises a plurality of faces substantially perpendicular to an axis of the cylindrical member further comprising.

14. The spark plug tool of claim 12, further comprising a weight disposed on or in the cylindrical member between a center portion of the cylindrical member and the second end.

15. The spark plug tool of claim 12, wherein the cavity has a circular opening.

16. The spark plug tool of claim 15, wherein a diameter of the circular opening is ⅜ inches.

17. The spark plug tool of claim 12, wherein a depth of the cavity is at least 2 inches.

18. The spark plug tool of claim 12, wherein a spacing between adjacent ridges of the plurality of ridges is at least 0.25 inches.

19. The spark plug tool of claim 12, wherein the cylindrical member comprises rubber.

20. The spark plug tool of claim 12, wherein a portion of the cylindrical member into which the cavity extends has a larger circumference than a portion of the cylindrical member into which the cavity does not extend.
